(19) United States
(12) Patent Application Publication
(10) Pub. No.: US 2013/0226683 A1
(43) Pub. Date: Aug. 29, 2013

(54) ONLINE VEHICLE BUYING SYSTEMS AND METHODS

(71) Applicants: James L. Bement, Dexter, MI (US); Brad E. Huyck, Northville, MI (US)

(72) Inventors: James L. Bement, Dexter, MI (US); Brad E. Huyck, Northville, MI (US)

(73) Assignee: GM Global Technology Operations LLC, Detroit, MI (US)

(21) Appl. No.: 13/440,469

(22) Filed: Apr. 5, 2012

Related U.S. Application Data
(60) Provisional application No. 61/602,381, filed on Feb. 23, 2012.

(51) Int. Cl. G06Q 30/02; G06Q 40/02; G06Q 30/06

(52) U.S. Cl. 705/14.23

(57) ABSTRACT

A method for online vehicle buying includes: transmitting vehicle inventory data for displaying an inventory of vehicles that are available for purchase from a dealership; in response to input indicating a desire to purchase one of the vehicles from the dealership, transmitting reward redemption data for displaying a first webpage for inputting information regarding an accrued monetary reward; determining an available award amount based on the information input to the first webpage; transmitting affiliation data for displaying a second webpage for inputting information regarding an affiliation with at least one of a manufacturer of the vehicles and a business affiliate of the manufacturer; determining an available discount based on the information input to the second webpage; determining a price for the one of the vehicles based on the available award amount and the available discount; and transmitting sale summary data for displaying the price of the one of the vehicles.

### CROSS-REFERENCE TO RELATED APPLICATIONS

This application claims the benefit of U.S. Provisional Application No. 61/602,381, filed on Feb. 23, 2012. The disclosure of the above application is incorporated herein by reference in its entirety.

### FIELD

The present application relates to systems and methods for buying vehicles from vehicle dealerships via the Internet.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A vehicle manufacturer designs and manufactures vehicles for sale to the public. The vehicle manufacturer does not, however, sell the vehicles to the public directly. Instead, the vehicle manufacturer sells the vehicles to vehicle dealers, and the vehicle dealers sell the vehicles to the public.

Purchasing a vehicle may be time consuming. A vehicle buyer may visit multiple dealerships in search of a vehicle having a desired set of characteristics. For example, a vehicle buyer may visit multiple dealerships in search of a vehicle having a desired transmission type, a desired engine type, a desired color, desired options, etc. At each dealership, the vehicle buyer may interact with one or more dealership employees regarding, for example, test driving a vehicle, vehicle pricing, financing, trading in a currently owned vehicle, etc. Generally speaking, the vehicle buyer interacts with a dealership employee to complete each step of the vehicle buying process.

### SUMMARY

A method for online vehicle buying includes: transmitting, using a server module, vehicle inventory data for displaying to a potential vehicle buyer an inventory of vehicles that are available for purchase from a vehicle dealership; in response to input from the potential vehicle buyer indicating a desire to purchase one of the vehicles from the dealership, transmitting, using the server module, reward redemption data for displaying to the potential vehicle buyer a first webpage for inputting information regarding an accrued monetary reward; determining, using the server module, an available award amount based on the information input to the first webpage; transmitting, using the server module, affiliation data for displaying to the potential vehicle buyer a second webpage for inputting information regarding an affiliation with at least one of a manufacturer of the vehicles and a business affiliate of the manufacturer; determining, using the server module, an available discount based on the information input to the second webpage; determining, using the server module, a price for the one of the vehicles based on the available award amount and the available discount; and transmitting, using the server module, sale summary data for displaying to the potential vehicle buyer the price of the one of the vehicles.

A system for online vehicle buying includes a server module and a customer interface module. The server module transmits vehicle inventory data for displaying an inventory of vehicles that are available for purchase from a vehicle dealership. The customer interface module, based on the vehicle inventory data, displays the inventory of vehicles that are available for purchase from the dealership on a display. The customer interface module receives user input indicating a desire to purchase one of the vehicles from the dealership. In response to the user input indicating a desire to purchase one of the vehicles from the dealership, the server module transmits reward redemption data for displaying a first webpage for inputting information regarding an accrued monetary reward. Based on the reward redemption data, the customer interface module displays the first webpage for inputting information regarding an accrued monetary reward on the display. The server module determines an available award amount based on the information input to the first webpage. The server module transmits affiliation data for displaying a second webpage for inputting information regarding an affiliation with at least one of a manufacturer of the vehicles and a business affiliate of the manufacturer. Based on the affiliation data, the customer interface module displays the second webpage for inputting information regarding an affiliation with at least one of a manufacturer of the vehicles and a business affiliate of the manufacturer. The server module determines an available discount based on the information input to the second webpage, determines a price for the one of the vehicles based on the available award amount and the available discount, and transmits sale summary data for displaying the price of the one of the vehicles. Based on the sale summary data, the customer interface module displays the price of the one of the vehicles on the display.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle supply chain according to the present disclosure;

FIG. 2 is a functional block diagram of an example vehicle buying system according to the present disclosure; and

FIGS. 3A-3C are a flowchart depicting an example method of buying a vehicle according to the present disclosure.

### DETAILED DESCRIPTION

Some vehicle buyers dislike the traditional, in-person vehicle buying process. The present application involves systems and methods that enable a vehicle buyer to purchase a vehicle from a dealership via the Internet. The vehicle buyer can complete one or more steps of the vehicle buying process online which would otherwise be completed in person at the dealership.

For example, the vehicle buyer can search the dealership's vehicle inventory and conduct vehicle research online. Once the vehicle buyer has selected a vehicle from the dealership's inventory, the vehicle buyer can schedule a test drive of the vehicle online. The vehicle buyer can specify a time, date, and location for the test drive online including specifying locations other than the dealership.

The vehicle buyer can determine available incentives and offers for the selected vehicle online. The vehicle buyer can determine a reward amount that the vehicle buyer has accrued online. The vehicle buyer may determine a discount that the vehicle buyer is entitled to receive online. The vehicle buyer may be entitled to a discount, for example, based on employment of the vehicle buyer or a relationship with an eligible family member.

The vehicle buyer can obtain an estimated value of a trade-in vehicle online. The vehicle buyer can also schedule an appointment for a representative of the dealership to view and provide a value of the trade-in vehicle online. The vehicle buyer can specify a time, date, and location for the appointment online including specifying locations other than the dealership.

The vehicle buyer can determine accessories that are available for addition to the selected vehicle online. If the vehicle buyer purchases the selected vehicle, selected accessories can be added to the vehicle by the dealership before delivery of the selected vehicle. The vehicle buyer can determine insurance and warranties that are available for purchase with the selected vehicle online. The vehicle buyer may purchase the selected vehicle online. The purchase price of the selected vehicle may be adjusted online based on incentives, offers, a reward amount, a discount, accessories, insurance and warranties, and estimated value of a trade-in vehicle entered online.

The vehicle buyer can also apply for and secure financing for the purchase of the selected vehicle online. The vehicle buyer may also electronically sign/execute financing documents and vehicle purchase agreements for the selected vehicle online. The vehicle buyer can schedule an appointment for delivery of a selected vehicle online. The vehicle buyer can specify a time, date, and location for delivery of the selected vehicle online including specifying locations other than the dealership. The vehicle buyer can also engage in an online chat session with a representative of the dealership if a representative is available. The above allows the vehicle buyer to control the vehicle buying process and the extent to which representatives of the dealership are involved.

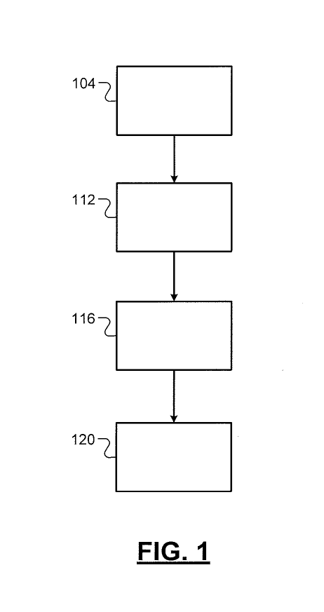

Referring now to FIG. 1, a functional block diagram of an example vehicle supply chain is presented. A vehicle manufacturer 104 manufacturers (new) vehicles. The vehicle manufacturer 108 may manufacture a plurality of different types of vehicles and a plurality of different models of vehicles. Each type and model of vehicle may be manufactured in a variety of colors and with a variety of different options. The vehicle manufacturer 104 may send the vehicles to a distribution center 112. While only the distribution center 112 is shown, the vehicle manufacturer 104 may send vehicles to a plurality of distribution centers, such as regional distribution centers.

The distribution center 112 selectively distributes vehicles to authorized dealers of the vehicles, such as dealership 116. While only the dealership 116 is shown, the distribution center 112 may also distribute vehicles to other authorized dealers that are located within a geographic region served by the distribution center 112. Authorized dealers may refer to dealers that have an existing agreement with the vehicle manufacturer 104 to maintain a dealership/storefront where the vehicle manufacturer's 104 vehicles will be sold to the public.

Vehicle buyers, such as customer 120, may visit the dealership 116 to view, test drive, secure financing, and purchase a vehicle. The present application will be discussed in terms of the customer 120 and the dealership 116. However, the present application is applicable to other customers and other authorized dealers.

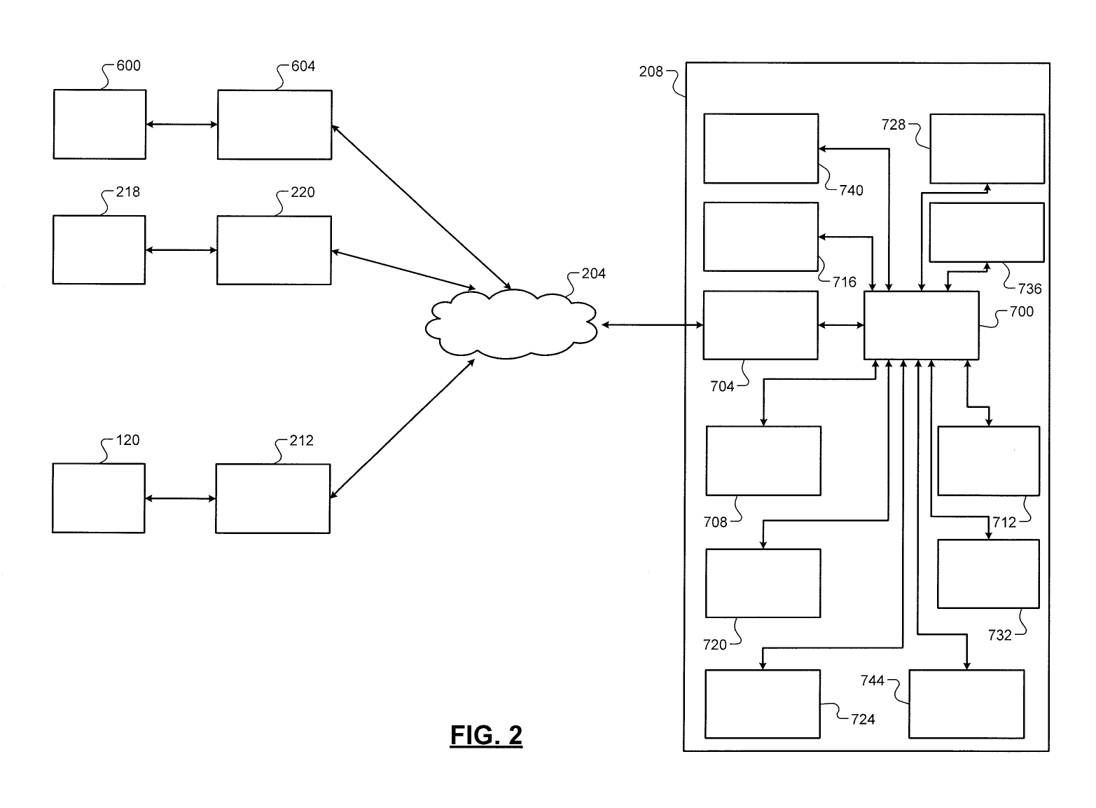

Referring now to FIG. 2, a functional block diagram of an example vehicle buying system is presented. The customer 120 can also purchase a vehicle from the dealership 116 via the Internet 204. One or more representatives of the dealership 116 communicate with a server module 208 to establish and maintain a website for the dealership 116 (hereafter “the website).

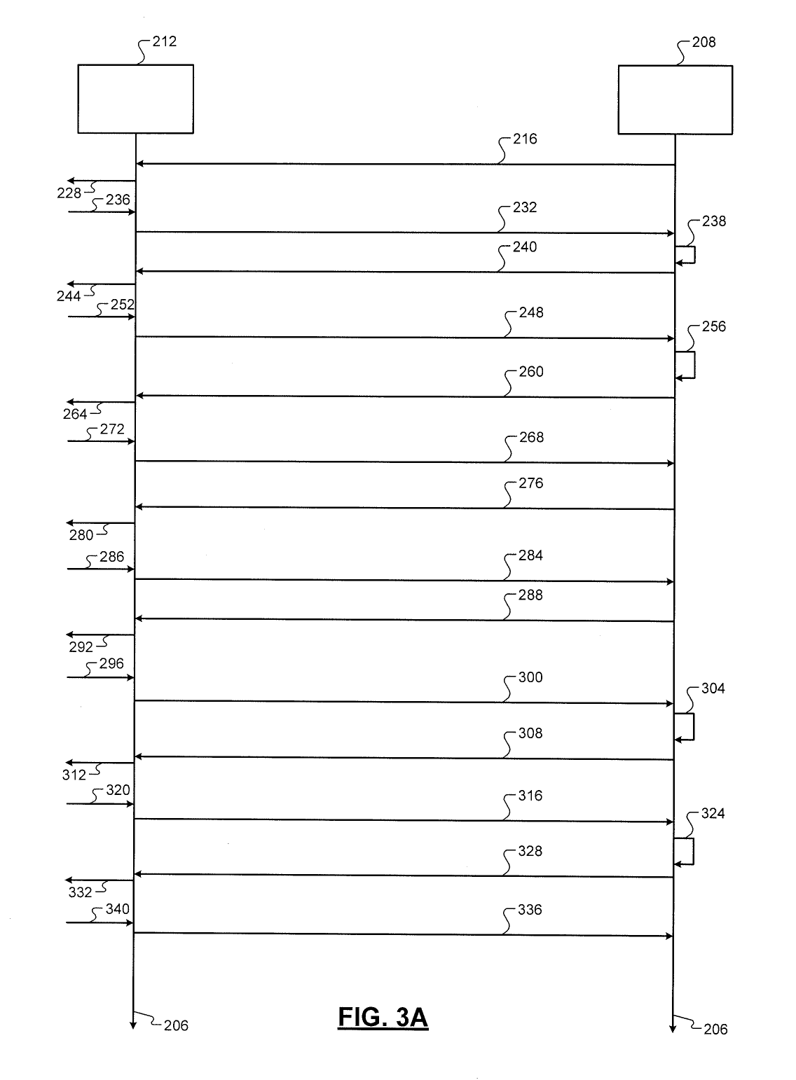

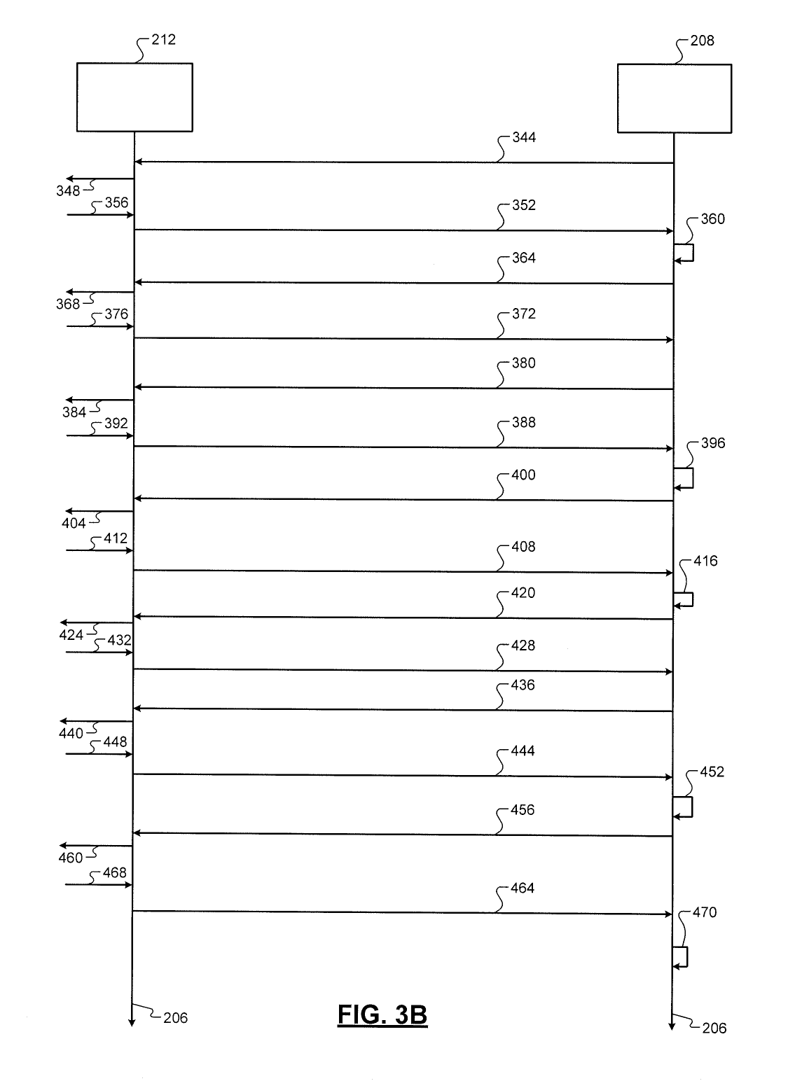

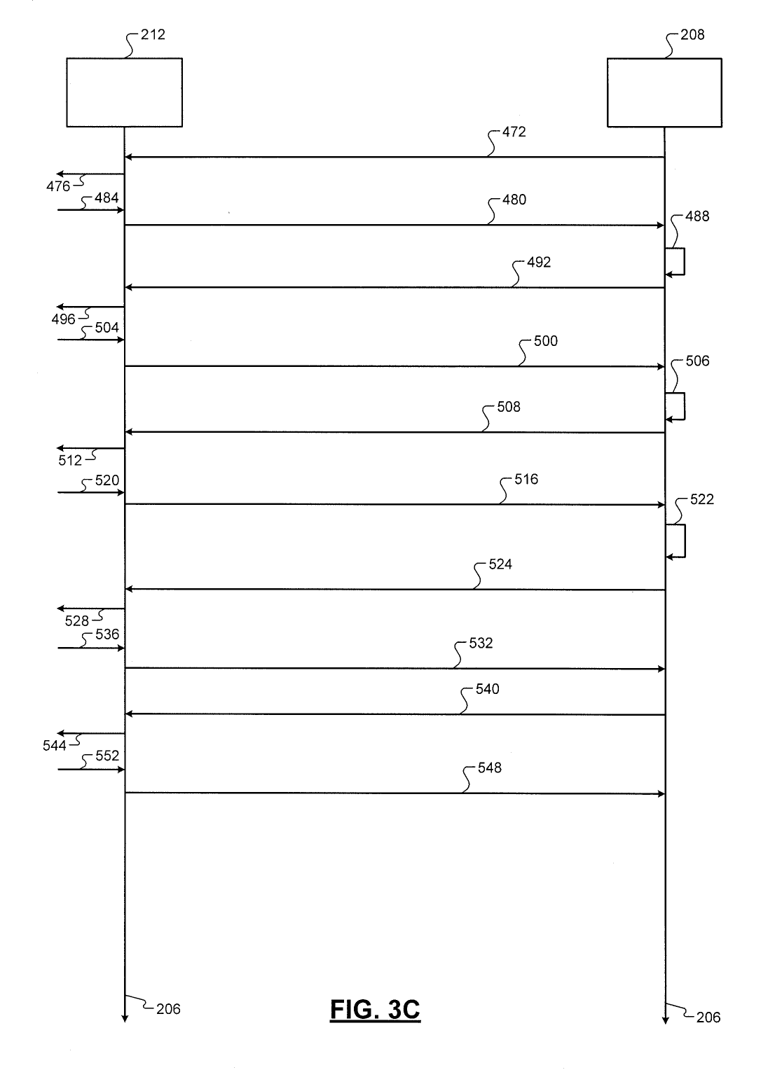

FIGS. 3A-3C include a flowchart depicting an example method of purchasing a vehicle via the Internet 204 over time 206. Referring now to FIGS. 2 and 3A, the customer 120 interfaces the website via the Internet 204 using a customer interface module 212. The customer interface module 212 may include an internet browser and a device, such as a computer, a tablet, a mobile device (e.g., a cellular phone), or another suitable type of device. The customer interface module 212 may access the Internet 204 wirelessly, by wire, or a combination thereof.

In response to a request for the website, the server module 208 transmits website data 216 to the customer interface module 212. For example only, the customer 120 may input the domain name of the website to an internet browser or the customer 120 may be directed to the website via a search engine or another website, such as a website associated with the vehicle manufacturer 104. The server module 208 may include a user interface module 700 that sends and receives data via an input/output (I/O) module 704.

A user (for the dealership 116) 218 inputs information for the website. The information may include, for example, text regarding the vehicles that are in the inventory of the dealership 116 and other information. In various implementations, text regarding the vehicles that are in the inventory of the dealership 116 may be populated by the server module 208. For example, based on vehicle identification numbers (VINs) of vehicles, the server module 208 may information for each of the vehicles, such as color, options, etc. The user 218 may upload media for the website, such as images, video, and/or audio of the vehicles that are in the inventory of the dealership 116. In various implementations, the server module 208 may generate digital renderings of the vehicles that are in the inventory of the dealership 116. The user 218 may input data for the website, for example, using a keyboard, a mouse, a touchscreen display, other devices, etc.

The user 218 interfaces the server module 208 via the Internet 204 using a dealer interface module 220. The dealer interface module 220 may include an internet browser and a device, such as a computer, a tablet, a mobile device (e.g., a cellular phone), or another suitable type of device. The server module 208 may authenticate that the user 218 is authorized to edit the website, for example, by requiring the user 218 to input a username and password that is associated with the dealership 116. Information for the website and the dealership 116 may be stored in a dealership information module 708, and the dealership information module 708 may provide the text and the media for the website.

The customer interface module 212 renders a homepage of the website based on the website data 216 and displays the homepage to the customer 120 on a display as illustrated by 228. Based on input from the customer 120, the customer interface module 212 transmits a vehicle inventory request 232 to the server module 208. The vehicle inventory request 232 is a request to display vehicles that are in the inventory of the dealership 116. The vehicle inventory request 232 may specify characteristics for the results, such as model year, vehicle type (e.g., car, truck, sport utility vehicle, or van), price range, estimated fuel consumption (e.g., in miles per gallon), and other suitable characteristics. The customer interface module 212 transmits the vehicle inventory request 232 to the server module 208 in response to receipt of user input 236 that is indicative of a request to display the inventory of the dealership 116. The customer 120 may generate input, for example, using a keyboard, a mouse, a touchscreen display, other peripheral devices, etc.

The dealership information module 708 may determine/identify vehicles that are in the inventory of the dealership 116 based on the vehicle inventory request 232 as indicated by 238. The server module 208 transmits vehicle inventory data 240 to the customer interface module 212 based on the identified vehicles that are in the inventory of the dealership 116.

The customer interface module 212 renders a vehicle inventory webpage based on the vehicle inventory data 240 and displays the vehicle inventory webpage to the customer 120 on the display as illustrated by 244. The vehicle inventory webpage may include images of the identified vehicles along with information about the identified vehicles, respectively. For example only, the vehicle inventory webpage may include information about engine, color, vehicle identification number (VIN), interior finishes, exterior color, transmission, options, drive configuration (e.g., two wheel, four-wheel, all-wheel, etc.), manufacturers' suggested retail price (MSPR), and/or other suitable information with the image of a given vehicle.

Based on input from the customer 120, the customer interface module 212 may transmit a selected vehicle request 248 to the server module 208. The customer interface module 212 may transmit the selected vehicle request 248 to the server module 208 in response to receipt of user input 252 that is indicative of a request for more information regarding a selected one of the vehicles displayed on the vehicle inventory webpage.

The dealership information module 708 may identify information and images that are specific to the selected vehicle as indicated by 256. The server module 208 transmits vehicle data 260 to the customer interface module 212 based on the identified information and images for the selected vehicle.

The customer interface module 212 renders a vehicle webpage based on the vehicle data 260 and displays the vehicle webpage to the customer 120 on the display as illustrated by 264. The vehicle webpage may include one or more images that have been uploaded to the server module 208 for the selected vehicle. The images may be presented in a slideshow in various implementations. The vehicle webpage may also include information about the selected vehicle, such as the information displayed on the vehicle inventory webpage for the selected vehicle and other information for the selected vehicle, such as the estimated fuel consumption of the selected vehicle, standard equipment, and installed options/accessories.

Based on input from the customer 120, the customer interface module 212 may transmit a vehicle purchase request 268 to the server module 208. The customer interface module 212 may transmit the vehicle purchase request 268 to the server module 208 in response to receipt of user input 272 that is indicative of a request to purchase the selected vehicle.

The server module 208 generates vehicle purchase data 276 in response to the vehicle purchase request 268 and transmits the vehicle purchase data 276 to the customer interface module 212. The customer interface module 212 renders a vehicle purchase webpage based on the vehicle purchase data 276 and displays the vehicle purchase webpage to the customer 120 on the display as illustrated by 280. The vehicle purchase webpage may include an initial price of the vehicle and one or more images that have been uploaded to the server module 208 for the selected vehicle.

Based on input from the customer 120, the customer interface module 212 may transmit a continue purchase request 284 to the server module 208. The customer interface module 212 may transmit the continue purchase request 284 to the server module 208 in response to receipt of user input 286 that is indicative of a request to continue with the purchase the selected vehicle.

The server module 208 generates incentives/offers data 288 in response to the continue purchase request 284 and transmits the incentives/offers data 288 to the customer interface module 212. The customer interface module 212 may render an offers and incentives webpage based on the incentives/offers data 288 and display the offers and incentives webpage to the customer 120 on the display as illustrated by 292. The offers and incentives webpage may include a field for the customer 120 to input a location, such as a zip code, for determining vehicle purchase incentives that may be available to the customer 120. Based on user input 296 to the offers and incentives webpage, the customer interface module 212 transmits location data 300 to the server module 208. The location data 300 may include the location input by the customer 120.

Information as to vehicle purchase incentives may be stored in a pricing module 712, and the pricing module 712 may determine the vehicle purchase incentives as indicated by 304. The vehicle purchase incentives that may be available to the customer 120 may be determined based on the location input by the customer 120. Example vehicle purchase incentives include, for example, a special (i.e., lower) interest rate that is available to qualified buyers of the selected vehicle and a cashback amount that is available to buyers of the selected vehicle.

The server module 208 generates reward data 308 for redeeming a reward (e.g., points, miles, reward money, etc.) accrued. A reward may be accrued, for example, using a credit card that is associated with the vehicle manufacturer 104. The customer interface module 212 may render a reward redemption webpage based on the reward data 308 and display the reward redemption webpage to the customer 120 on the display as illustrated by 312. The reward redemption webpage may include fields for the customer 120 to input information, for example, regarding an account where the reward was accrued, the last name of the customer 120, and other information that can be used to determine an amount of the reward.

The customer interface module 212 transmits account data 316 to the server module 208 based on user input 320 to the reward redemption webpage. A reward module 716 may determine a reward amount based on the account data 316 as indicated by 324. The server module 208 generates reward amount data 328 indicative of the reward amount.

The customer interface module 212 may update the reward redemption webpage based on the reward amount data 328 to indicate the reward amount, if any, to the customer 120 as indicated by 332. The server module 208 may wait for response data 336 that is indicative of an input 340 by the customer 120 as to an acknowledgement, an acceptance of the reward amount, etc.

Referring now to FIGS. 2 and 3B, the server module 208 may generate trade-in request data 344. The customer interface module 212 may render a trade-in information webpage based on the trade-in request data 344 and display the trade-in information webpage to the customer 120 on the display as illustrated by 348. The trade-in information webpage may include fields for the customer 120 to input information regarding a vehicle that will be traded in (i.e., a trade-in vehicle). The customer 120 may input information including a model year of the trade-in vehicle, a make (e.g., manufacturer) of the trade-in vehicle, a model of the trade-in vehicle, a type of the model of the trade-in vehicle, mileage of the trade-in vehicle, and a condition of the trade-in vehicle, and equipment and options of the trade-in vehicle.

The customer interface module 212 transmits trade-in vehicle data 352 to the server module 208 based on user input 356 to the trade-in information webpage. A trade-in estimation module 720 may determine an estimated value of the trade-in vehicle based on the trade-in vehicle data 352 and the location input by the customer 120 as indicated by 360. For example only, the trade-in estimation module 720 may determine the estimated value of the trade-in vehicle using, for example, Kelly Blue Book valuation, NADA vehicle valuation, BlackBook valuation, or another suitable vehicle valuation method. The trade-in estimation module 720 may determine the estimated value of the trade-in vehicle based on a predetermined percentage, fraction, or amount less than the Kelly Blue Book valuation, NADA vehicle valuation, or BlackBook valuation of the trade-in vehicle in various implementations.

The server module 208 generates trade-in value data 364 based on the value of the trade-in vehicle. The customer interface module 212 may update the trade-in information webpage to display the value of the trade-in vehicle to the customer 120 as indicated by 368. The customer interface module 212 may also update the trade-in information webpage to enable the customer 120 to select whether payments are still being made on the trade-in vehicle and, if so, an amount owed on the trade-in vehicle. The customer interface module 212 may also update the trade-in information webpage to include a field for the customer 120 to input his or her own estimated value of the trade-in vehicle.

If the customer 120 inputs an estimated value of the trade-in vehicle, the value input by the customer 120 may be used as the estimated value of the trade-in vehicle instead of the estimated value of the trade-in vehicle determined by the server module 208. In any case, however, the value of the trade-in vehicle that is used to determine the cost of the selected vehicle to the customer 120 will be determined by a representative of the dealership 116 after physical inspection of the trade-in vehicle. The customer interface module 212 generates trade-in value response data 372 based on user input 376 to the updated trade-in information webpage.

As an alternative to inputting information as to the trade-in vehicle to the trade-in information webpage, the customer interface module 212 may generate a schedule valuation request (not shown) in response to user input to the trade-in information webpage. A scheduling module 724 may generate valuation scheduling data for a schedule trade-in valuation webpage, and the schedule trade-in valuation webpage may be displayed to the customer 120 in response to the schedule valuation request.

The schedule trade-in valuation webpage may include, for example, fields regarding a date, time, and location at which the customer 120 would like a representative of the dealership 116 to view the trade-in vehicle in person and provide an estimated value of the trade-in vehicle. Trade-in valuations at locations other than at the dealership 116 may be provided at no additional cost to the customer 120. In response to user input to the schedule trade-in valuation webpage, the server module 208 may transmit a message (e.g., an email) to a representative of the dealership 116 indicating the date, time, and location where the customer 120 will have the trade-in vehicle for providing the estimated value of the trade-in vehicle.

The server module 208 may generate affiliation request data 380. The customer interface module 212 may render an affiliation discount webpage based on the affiliation request data 380 and display the affiliation discount webpage to the customer 120 on the display as illustrated by 384. The affiliation discount webpage may include fields for the customer 120 to input information regarding an affiliation between the vehicle manufacturer 104 and the customer 120 or a family member of the customer 120. For example only, the customer 120 can input information regarding employment of the customer 120 or an eligible family member of the customer 120 with the vehicle manufacturer 104. For another example only, the customer can input information regarding employment of the customer or an eligible family member of the customer 120 with a supplier or other business associate of the vehicle manufacturer 104. The information may include, for example, a string of numbers and/or other types of characters.

The customer interface module 212 generates affiliation data 388 based on user input 392 to the affiliation discount webpage. An affiliation module 728 may determine a discount for the initial price of the selected vehicle based on the affiliation data 388 as indicated by 396. The server module 208 generates affiliation discount data 400 that is indicative of the discount. The discount may include, for example, an amount (value) or a percentage of the initial price of the selected vehicle.

The customer interface module 212 updates the affiliation discount webpage based on the discount as indicated by 404. The customer interface module 212 generates affiliation response data 408 based on user input 412 to the updated affiliation discount webpage. The affiliation response data 408 may indicate an input by the customer 120 as to an acknowledgement, an acceptance of the discount, etc.

Based on the initial price of the selected vehicle, the reward amount (if applicable), the value of the trade-in (if applicable), the affiliation discount (if applicable), and the vehicle purchase incentives (if applicable), the pricing module 712 may determine pricing options for qualified buyers of the selected vehicle as indicated by 416. The server module 208 generates pricing data 420 based on the pricing options. The customer interface module 212 generates a vehicle pricing webpage based on the pricing data 420 and displays the vehicle pricing webpage to the customer 120 on the display as illustrated by 424. Qualified buyers may refer to vehicle buyers that, based on their credit worthiness, qualify for a best available interest rate.

The vehicle pricing webpage may include one or more estimated monthly payments for qualified buyers of the selected vehicle. If more than one vehicle purchase incentives (e.g., both a special interest rate and a cash back discount) are available, the vehicle pricing webpage may include an estimated monthly payment for qualified buyer under each of the selected vehicle purchase incentives. The vehicle pricing webpage may include fields for the customer 120 to input a down payment amount for each vehicle purchase incentive, whether to include taxes and fees in the estimated monthly payments, interest rate, and payment period (e.g., number of months). The vehicle pricing webpage may also include a field for the customer 120 to select whether the customer 120 will use his or her own financing source. The estimated monthly payment(s) may be updated based on the customer's 120 selections from the vehicle pricing webpage.

The customer interface module 212 transmits purchase data 428 to the server module 208 based on user input 432 to the vehicle pricing webpage. If the vehicle buyer does not select that the customer 120 will use his or her own financing, the server module 208 generates financing request data 436 for the customer 120. The customer interface module 212 renders a financing request webpage based on the financing request data 436 and displays the financing request webpage to the customer 120 on the display as illustrated by 440.

The financing request webpage includes fields for the customer 120 to input personal information for determining a credit worthiness of the customer 120. The personal information may include, for example, first name, last name, address, city, state, zip code, period at present address (e.g., in years and months), phone number, email, residence type (e.g., owns home, buying home, living with relatives, renting/leasing, etc.), monthly payment for residence, and unique identifier of the customer 120 (e.g., social security number). The personal information may also include, for example, date of birth, employment status (e.g., full time, part time, retired, military, self-employed, contract employee, seasonal employee, temporary employee, unemployed, etc.), period of that employment status (e.g., in years and months), gross income, and period for the stated gross income (e.g., bi-weekly, weekly, semi-monthly, monthly, yearly, etc.).

The customer interface module 212 generates financing information data 444 based on user input 448 to the financing request webpage. The customer interface module 212 encrypts the personal information input by the customer 120 before generating the financing information data 444.

A financing module 732 may determine available financing options based on the personal information input by the customer 120 as indicated by 452. If the customer 120 selected a special interest rate, the financing module 732 may determine whether the customer 120 is eligible for the special financing rate based on the personal information input by the customer 120. If the customer did not select a special interest rate, the financing module 732 may determine a credit worthiness value (e.g., credit score) for the customer 120 based on the personal information input by the customer 120. The financing module 732 may determine available financing options based on the credit worthiness value determined for the customer 120.

The server module 208 generates available financing data 456 based on the available financing options for the customer 120. The customer interface module 212 renders an available financing webpage based on the available financing data 456 and displays the available financing webpage to the customer 120 on the display as illustrated by 460. The available financing webpage may include estimated monthly payments for each of the available financing options and fields for the customer 120 to select one of the available financing options for purchasing the selected vehicle. The customer interface module 212 generates financing selection data 464 based on user input 468 to the available financing webpage.

An accessories and warranties module 736 may determine accessories that are available to be added to the selected vehicle by the dealership 116 (if any) as indicated by 470. Referring now to FIGS. 2 and 3C, the server module 208 generates available accessory data 472 based on the available accessories. The customer interface module 212 renders an available accessories webpage based on the available financing data 472 and displays the available accessories webpage to the customer 120 on the display as illustrated by 476.

The available accessories webpage includes fields for the customer 120 to select available accessories for the selected vehicle and costs associated with each of the available accessories. The available accessories webpage may also include text descriptions, images, and/or other media for available accessories. The customer interface module 212 generates selected accessories data 480 based on user input 484 to the available accessories webpage.

The accessories and warranties module 736 may determine warranties and insurance contracts that can be purchased for the selected vehicle (if any) as indicated by 488. The server module 208 generates available contracts data 492 based on the available warranties and insurance contracts that can be purchased for the selected vehicle. The customer interface module 212 renders an available insurance and warranties webpage based on the available contracts data 492 and displays the available insurance and warranties webpage to the customer 120 on the display as illustrated by 496.

The available insurance and warranties webpage includes fields for the customer 120 to select available insurance and warranties for the selected vehicle and costs associated with each of the available types of insurance and warranty. The available insurance and warranties webpage may also include text descriptions, terms, etc. for available insurance and/or warranties. Examples of insurance and warranty contracts that may be available include, rim and tire damage insurance, roadside assistance, gap insurance, maintenance warranties, extended powertrain warranties, life insurances, etc. The customer interface module 212 generates selected insurance and warranties data 500 based on user input 504 to the available insurance and warranties webpage.

The pricing module 712 may determine a summary for the sale of the selected vehicle as indicated by 506 based on all of the input from the customer 120. The server module 208 generates sale summary data 508 based on the summary of the sale of the selected vehicle. The financing module 732 may also update financing information (e.g., the amount to be financed) based on the selected accessories and the selected insurance and warranties. The financing module 732 may generate (electronic) financing documents for execution by the customer 120, and the server module 208 generate the sale summary data 508 based on the financing documents. The pricing module 712 may generate (electronic) purchase agreement documents for the selected vehicle for execution by the customer 120, and the server module 208 generate the sale summary data 508 based on the purchase agreement documents.

The customer interface module 212 renders a sale summary webpage based on the sale summary data 508 and displays the sale summary webpage to the customer 120 on the display as illustrated by 512. The sale summary webpage may include the final details of the sale of the selected vehicle for review by the customer 120. The sale summary webpage may also include the financing documents and purchase agreement documents for (electronic) execution by the customer 120.

The sale summary webpage may also include one or more fields for the customer 120 to input or upload identifiers of the customer 120 for verification of the identity of the customer 120. For example only, the identifiers of the customer 120 may include the social security number of the customer 120, an image of the customer's 120 government issued identification, an image of the customer's 120 birth certificate, an image of the customer's 120 social security card, an image of the customer's 120 passport, an image of one or more of the customer's 120 credit cards, and/or one or more other suitable identifiers of the customer 120.

The customer interface module 212 generates sale acknowledgement data 516 based on user input and uploads 520 to the sale summary webpage. A buyer identification (ID) verification module 740 may verify the identity of the customer 120 based on the identifiers of the customer 120 as indicated by 522. The server module 208 may transmit the electronically executed financing documents and the electronically executed vehicle purchase agreements to the dealership 116. In various implementations, such as where electronic signature and verification of the identity of the customer 120 are not used, the financing documents and the vehicle purchase agreements may be transmitted to the dealership 116 unsigned, and the financing documents and the vehicle purchase agreements may be executed by the customer 120 at the taking of delivery of the selected vehicle.

The server module 208 generates titling information request data 524. The customer interface module 212 renders a titling information webpage based on the titling information request data 524 and displays the titling information webpage to the customer 120 on the display as illustrated by 528. The titling information webpage includes fields for the customer 120 to input text that should be listed on the title of the selected vehicle.

The customer interface module 212 generates titling information data 532 based on user input 536 to the titling information webpage. The server module 208 provides the text that should be listed on the title of the selected vehicle to the dealership 116 so the dealership 116 can prepare the necessary documents for transferring title and (license) plating the selected vehicle.

The server module 208 generates delivery request data 540 for scheduling the delivery of the selected vehicle to the customer 120. The customer interface module 212 renders a delivery scheduling webpage based on the delivery request data 540 and displays the delivery scheduling webpage to the customer 120 on the display as illustrated by 544. The delivery scheduling webpage may include fields for the customer 120 to input a desired date and time for delivery of the selected vehicle and to input a location for the delivery of the selected vehicle, such as the home of the customer 120, another location input by the customer 120, or at the dealership 116. Deliveries at locations other than at the dealership 116 may be provided at no additional cost to the customer 120.

The customer interface module 212 generates delivery scheduling data 548 based on user input 552 to the delivery scheduling webpage. The server module 208 may transmit the delivery scheduling data 548 to the dealership 116 so the dealership 116 can deliver the selected vehicle to the customer 120 at the date, time, and location input by the customer 120.

The scheduling module 724 may enable the customer 120 to schedule a test drive of the selected vehicle. A schedule test drive link may be provided on one or more of the above webpages. The server module 208 may generate test drive scheduling data (not shown) in response to the customer 120 selecting the schedule test drive link.

The customer interface module 212 renders a test drive scheduling webpage based on the test drive scheduling data and displays the test drive scheduling webpage to the customer 120 on the display. The test drive scheduling webpage may include fields for the customer 120 to input a desired date and time for the customer 120 to conduct a test drive of the selected vehicle and to input a location where the test drive will begin, such as the home of the customer 120, another location input by the customer 120, or at the dealership 116. Test drives from locations other than at the dealership 116 may be provided at no additional cost to the customer 120.

The customer interface module 212 generates test drive scheduling data (not shown) based on user input to the test drive scheduling webpage. The server module 208 may transmit the test drive scheduling data to the dealership 116 so a representative of the dealership 116 can bring the selected vehicle to the location input by the customer 120 at the date and time input by the customer 120.

A chat module 744 enables the customer 120 to enter into and conduct a chat session with a representative 600 of the dealership 116 (see FIG. 2). The chat session may be a text chat session, a voice chat session, a video chat session, or a combination thereof. A chat link may be provided on the dealers' website and all of the above webpages. By selecting the chat link, the customer 120 can enter into a chat session at any time at any stage of the vehicle buying process, so long as a representative of the dealership 116 is available. When the customer 120 selects the chat link, the server module 208 may open a communication channel between the customer interface module 212 and a chat interface module 604 for the chat session. The customer 120 (via the customer interface module 212) can then chat with the representative 600 (via the chat interface module 604). The chat interface module 604 may be included in a computer, a tablet, a mobile device (e.g., a cellular phone), or another suitable type of device.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

What is claimed is:

1. A method for online vehicle buying, comprising:
transmitting, using a server module, vehicle inventory data for displaying to a potential vehicle buyer an inventory of vehicles that are available for purchase from a vehicle dealership;
in response to input from the potential vehicle buyer indicating a desire to purchase one of the vehicles from the dealership, transmitting, using the server module, reward redemption data for displaying to the potential vehicle buyer a first webpage for inputting information regarding an accrued monetary reward;
determining, using the server module, an available award amount based on the information input to the first webpage;
transmitting, using the server module, affiliation data for displaying to the potential vehicle buyer a second webpage for inputting information regarding an affiliation with at least one of a manufacturer of the vehicles and a business affiliate of the manufacturer;
determining, using the server module, an available discount based on the information input to the second webpage;
determining, using the server module, a price for the one of the vehicles based on the available award amount and the available discount; and
transmitting, using the server module, sale summary data for displaying to the potential vehicle buyer the price of the one of the vehicles.

2. The method of claim 1 further comprising:
transmitting, using the server module, trade-in request data for displaying to the potential vehicle buyer a third webpage for inputting information regarding a trade-in vehicle to be purchased by the dealership;
determining, using the server module, an estimated value of a trade-in vehicle based on the information input to the third webpage; and
determining the price of the one of the vehicles further based on the estimated value.

3. The method of claim 1 further comprising:
transmitting, using the server module, trade-in valuation scheduling data for displaying to the potential vehicle buyer a fourth webpage for selecting a time, a date, and a location for a representative of the dealership to view and determine a value of a trade-in vehicle at the location; and
transmitting, using the server module, an indicator of the time, the date, and the location to the dealership.

4. The method of claim 3 wherein the location is different than a location of the dealership.

5. The method of claim 1 further comprising selectively opening, using the server module, a communication channel between a representative of the dealership and the potential vehicle buyer in response to input from the potential vehicle buyer indicating a desire to enter into a chat session.

6. The method of claim 1 further comprising:
transmitting, using the server module, financing request data for displaying to the potential vehicle buyer a fifth webpage for inputting information for obtaining financing for the price of the one of the vehicles;
determining, using the server module, an indicator of a credit worthiness of the potential vehicle buyer based on the information input to the fifth webpage;
determining, using the server module, available financing options for the potential vehicle buyer based on the indicator of the credit worthiness of the potential vehicle buyer; and
determining the price of the one of the vehicles further based on a selected one of the available financing options.

7. The method of claim 1 further comprising:
transmitting, using the server module, delivery request data for displaying to the potential vehicle buyer a sixth webpage for selecting a time, a date, and a location for the potential vehicle buyer to take delivery of the one of the vehicles; and
transmitting, using the server module, an indicator of the time, the date, and the location to the dealership.

8. The method of claim 7 wherein the location is different than a location of the dealership.

9. The method of claim 1 further comprising:
transmitting, using the server module, available accessory data for displaying to the potential vehicle buyer a seventh webpage for selecting accessories that are available for addition to the one of the vehicles by the dealership before delivery of the one of the vehicles; and
determining the price of the one of the vehicles further based on prices of ones the accessories selected by the potential vehicle buyer via the seventh webpage.

10. The method of claim 1 further comprising:
transmitting, using the server module, available contracts data for displaying to the potential vehicle buyer an eighth webpage for selecting contracts that are available for purchase with the one of the vehicles; and
determining the price of the one of the vehicles further based on prices of ones of the contracts selected by the potential vehicle buyer via the eighth webpage.

11. A system for online vehicle buying, comprising:
a server module that transmits vehicle inventory data for displaying an inventory of vehicles that are available for purchase from a vehicle dealership; and
a customer interface module that, based on the vehicle inventory data, displays the inventory of vehicles that are available for purchase from the dealership on a display, that receives user input indicating a desire to purchase one of the vehicles from the dealership,
wherein, in response to the user input indicating a desire to purchase one of the vehicles from the dealership, the server module transmits reward redemption data for displaying a first webpage for inputting information regarding an accrued monetary reward,
wherein the customer interface module, based on the reward redemption data, displays the first webpage for inputting information regarding an accrued monetary reward on the display,
wherein the server module determines an available award amount based on the information input to the first webpage,
wherein the server module transmits affiliation data for displaying a second webpage for inputting information regarding an affiliation with at least one of a manufacturer of the vehicles and a business affiliate of the manufacturer,
wherein the customer interface module, based on the affiliation data, displays the second webpage for inputting information regarding an affiliation with at least one of a manufacturer of the vehicles and a business affiliate of the manufacturer,
wherein the server module determines an available discount based on the information input to the second webpage, determines a price for the one of the vehicles based on the available award amount and the available discount, and transmits sale summary data for displaying the price of the one of the vehicles, and
wherein the customer interface module, based on the sale summary data, displays the price of the one of the vehicles on the display.

12. The system of claim 11 wherein:
the server module transmits trade-in request data for displaying a third webpage for inputting information regarding a trade-in vehicle to be purchased by the dealership;
the customer interface module, based on the trade-in request data, displays the third webpage for inputting information regarding a trade-in vehicle to be purchased by the dealership on the display; and
the server module determines an estimated value of a trade-in vehicle based on the information input to the third webpage and determines the price of the one of the vehicles further based on the estimated value.

13. The system of claim 11 wherein:
the server module transmits trade-in valuation scheduling data for displaying a fourth webpage for selecting a time, a date, and a location for a representative of the dealership to view and determine a value of a trade-in vehicle at the location;
the customer interface module, based on the trade-in valuation scheduling data, displays the fourth webpage for selecting a time, a date, and a location for a representative of the dealership to view and determine a value of a trade-in vehicle at the location; and
the server module transmits an indicator of the time, the date, and the location input to the fourth webpage to the dealership.

14. The system of claim 13 wherein the location is different than a location of the dealership.

15. The system of claim 11 wherein the server module selectively opens a communication channel between a representative of the dealership and the potential vehicle buyer in response to user input to the customer interface module indicating a desire to enter into a chat session.

16. The system of claim 11 wherein:
the server module transmits financing request data for displaying a fifth webpage for inputting information for obtaining financing for the price of the one of the vehicles;
the customer interface module, based on the financing request data, displays the fifth webpage for inputting information for obtaining financing for the price of the one of the vehicles on the display; and
the server module determines an indicator of a credit worthiness of a potential vehicle buyer based on the information input to the fifth webpage, determines available financing options for the potential vehicle buyer based on the indicator of the credit worthiness of the potential vehicle buyer, and determines the price of the one of the vehicles further based on a selected one of the available financing options.

17. The system of claim 11 wherein:
the server module transmits delivery request data for displaying a sixth webpage for selecting a time, a date, and a location for the potential vehicle buyer to take delivery of the one of the vehicles;
the customer interface module, based on the delivery request data, displays the sixth webpage for selecting a time, a date, and a location for the potential vehicle buyer to take delivery of the one of the vehicles on the display; and
the server module transmits an indicator of the time, the date, and the location input to the sixth webpage to the dealership.

18. The system of claim 17 wherein the location is different than a location of the dealership.

19. The system of claim 11 wherein:
the server module transmits available accessory data for displaying a seventh webpage for selecting accessories that are available for addition to the one of the vehicles by the dealership before delivery of the one of the vehicles;
the customer interface module, based on the available accessory data, displays the seventh webpage for selecting accessories that are available for addition to the one of the vehicles by the dealership before delivery of the one of the vehicles on the display; and
the server module determines the price of the one of the vehicles further based on prices of ones the accessories selected via the seventh webpage.

20. The system of claim 11 wherein:
the server module transmits available contracts data for displaying an eighth webpage for selecting contracts that are available for purchase with the one of the vehicles;
the customer interface module, based on the available contracts data, displays the eighth webpage for selecting contracts that are available for purchase with the one of the vehicles on the display; and
the server module determines the price of the one of the vehicles further based on prices of ones of the contracts selected via the eighth webpage.
